(19) United States
(12) Patent Application Publication
(10) Pub. No.: US 2005/0212657 A1
(43) Pub. Date: Sep. 29, 2005

(54) Identity verification system with self-authenticating card

(76) Inventor: Rudy Simon, Dexter, ME (US)

Correspondence Address: BOHAN, MATHERS & ASSOCIATES, LLC, PO BOX 17707, PORTLAND, ME, 04112-8707, US

(21) Appl. No.: 11/065,228

(22) Filed: Feb. 24, 2005

Related U.S. Application Data
(63) Continuation-in-part of application No. 10/198,342, filed on Jul. 18, 2002.
(60) Provisional application No. 60/547,376, filed on Feb. 24, 2004.
(60) Provisional application No. 60/344,833, filed on Nov. 7, 2001.

(51) Int. Cl. G06F 7/04

(52) U.S. Cl. 340/5.74; 340/5.52; 340/5.6; 382/115; 382/129; 235/492

(57) ABSTRACT

An identity verification system that includes a self-authenticating identity card and a card reader. The self-authenticating card has a programmable microchip with data pertaining to the authorized card bearer, including data for a stored biometric feature, such as a fingerprint, a retinal scan, a voice print, a DNA sequence, etc. The card also includes a biometric sensor that senses an applied biometric feature and a data lock that releases data upon determinination of a match between the stored and the applied biometric features. In order to self-authenticate the card, the card bearer must provide the applied biometric feature. For example, the card bearer applies a finger tip to the sensor, if the applied biometric feature is a fingerprint. If the data match, the data lock transmits data stored on the card to the card reader for processing.

### BACKGROUND OF THE INVENTION

1. Field of the Invention

The present invention relates generally to the field of personal identity verification, and particularly, to a system of storing, reading, and verifying identity information.

2. Description of Related Art

The need for a tamper-proof ID card is described in detail in U.S. patent application Ser. No. 10/198,342, entitled “Identity Card and Tracking System” and filed on Jul. 18, 2002. That application is hereby incorporated herein in its entirety. Briefly, the earlier filed patent application discloses a tracking system comprising an ID card that bears personal data of a card bearer, in machine-readable form. The data includes biometric, as well as biographic, data that describes the legitimate card bearer. Ideally, the biometric data includes biometric features that are unique to the legitimate card bearer, such as a fingerprint, a retinal scan, a unique DNA sequence, a facial image, a voice print, etc. The data are digitally encoded and encrypted and are readable only with the appropriate scanning or reading device.

The ID card of in U.S. patent application Ser. No. 10/198,342 was envisioned as being used in conjunction with a database, such as a national registry, and with a network of readers or scanners that were linked to the national registry, either via land-based, satellite, or broadcast telecommunication means. Although this system is quite suitable for large institutions with the resources to implement a large, comprehensive ID card and tracking system, there remain many other applications for which quick and accurate verification of identity of a card bearer is desirable, but for which the costs and complexity of instituting such a large and comprehensive system are prohibitive. Many small, medium, even large-sized organizations would be well-served with an identity verification system that does not require a continuous data connection to a central database in order to verify the identity of the presenting card bearer. In addition, there are significant concerns regarding privacy rights of citizens that make it politically difficult to implement a comprehensive central database that collects and stores significant amounts of information about an individual.

Nevertheless, with increasing domestic and global threats to security and peace, reliable identification has become a top priority for many institutions, such as medical, governmental, and transportation services and facilities. Many facilities and institutions require some degree of control over access to the facility and/or services. For example, a large medical facility requires some control over access to the physical plant and, within the physical plant, access to certain areas or information. Many organizations that deal with natural and other types of disasters around the globe need a verification system that is inexpensive, easy to set up, and does not require bulky equipment or that each card reader be connected via a telecommunications link to a computer network. The U.S. patent application cited above discloses an ID card that provides many of the features of a tamper-proof card that carries data for one or more biometric features of the legitimate card bearer. What is needed in addition to the tamper-proof card is a stand-alone or mobile card-reading system for reading the data on the ID card and verifying the identity of the card bearer. In other words, what is needed is an ID card that contains all the necessary features and data to verify the identification of a card bearer, without relying on continuous access to a central database.

Today, most ID cards are simple in the sense that they have data stored on a magnetic stripe that provides access to locked areas of the facility. Often, the card bearer is required to enter a personal identification number (PIN) after the card is inserted into a conventional card reader, as a means of ensuring that the card bearer is the legitimate card bearer. There are difficulties involved with this system, most obviously, the fact that many people have difficulty remembering their PIN and, therefore, write it down and keep it in a location in close proximity to the card itself, for example, in the wallet. Typically, the name of the legitimate card bearer is printed in clear text on the card, and many cards today also include a photograph of the legitimate card bearer. Even if the card bearer has memorized the PIN and not written it down, the card bearer may still be forced to disclose the PIN to an unauthorized party under threat of violence. For example, if the card provides access to one's bank account via an automated teller machine, the other party may now use the PIN and the card to gain access to the card bearer's account to illegally draw funds from it. Currently, there is no method of authenticating the actual identity of the person using the card, and no way of intervening in the illegal act.

The weaknesses of such an ID card have been described in detail in the above-cited patent application. Very briefly, a person gaining illegitimate control of the card can see the name, professional designation, and the photograph of the card bearer. Accordingly, the illegitimate card bearer may disguise his or her appearance and provide false credentials to better correspond to the image and information provided on the card. Accurate verification of the identity of the card bearer by visual comparison of the appearance and credentials of the card bearer with the information on the card is far from reliable in the best of cases. People understand that personal appearance changes over time, due to aging and cosmetic changes, such as dying hair color, wearing colored contact lenses, etc., and a person comparing the image on the card with the appearance of the card bearer is predisposed to verify the identity of the card bearer, even if his or her appearance deviates noticeably from the image on the card. Thus, a person trying to verify the identity of the bearer of a card that has a photograph of the legitimate card bearer on it may easily be fooled into believing that the appearance of an illegitimate card bearer corresponds to the image on the card.

What is needed, therefore, is a self-authenticating data card system that includes a tamper-proof self-authenticating data card with biometric data encoded on it and card-reading apparatus for reading the identity card, including the biometric data. What is further needed is such a system that verifies the identity of the card bearer by comparing the biometric data stored on the card with biometric data contemporaneously taken from the card bearer. What is yet further needed is such a system that does not provide any information pertaining to the legitimate card bearer until the identity of the presenting card bearer has been verified. What is still yet further needed is such a system that is a mobile system that does not require a continuous link to a computer database for proper verification of the identity of the presenting card bearer.

### SUMMARY OF THE INVENTION

For the reasons cited above, it is an object of the present invention to provide a self-authenticating data card system comprising a tamper-proof identity card that carries biometric data and card-reading apparatus for reading the identity card, including the biometric data. It is a further object to provide such a system that verifies the identity of the card bearer by comparing the biometric data on the card with biometric data contemporaneously obtained from the card bearer. It is a yet further object to provide an ID card that provides no information on the identity of the authorized card bearer until the identity of the card bearer has been verified. It is a still yet further object to provide such a system that is a mobile system that provides identity verification of the presenting card bearer without requiring a continuous link to a computer database.

The objects are achieved by providing a self-authenticating data card system that includes a tamper-proof self-authenticating data card and identity-verification apparatus that includes a data display. The self-authenticating data card includes a programmable chip, a biometrics sensor, and a data lock. The programmable chip contains stored data that includes biographic and biometric data of the legitimate card bearer. The identity-verification apparatus includes a data processing unit for processing the stored data and circuitry for transmitting the stored data to the data processing unit. If the identity-verification apparatus also includes a biometrics sensor, the circuitry also controls release of the data lock. The biometrics sensor, which may be incorporated into the self-authenticating data card or or the identity-verification apparatus, senses a biometric feature of the presenting card bearer. The data lock is a software-controlled gate that compares the biometric data that is contemporaneously obtained from the presenting card bearer (actual biometric data) with the biometric data stored on the self-authenticating data card (stored biometric data). Upon determining a match between the actual biometric data and the stored biometric data, the data lock is released and the stored data are made available to the identity-verification apparatus for processing and display on the data display.

The term “presenting card bearer” as used hereinafter refers to the person presenting the self-authenticating data card in the course of an identity verification. The term “legitimate card bearer” as used hereinafter refers to the person to whom the self-authenticating data card was issued. The term “stored data” as used hereinafter includes both biographic and biometric data that is stored on the self-authenticating data card, whereas the term “stored biometric data” refers to the biometric data only that is stored on the card. The term “actual biometric data” refers to biometric data that is contemporaneously obtained from the presenting card bearer.

Insertion of the self-authenticating data card into the identity-verification apparatus activates the data lock, which awaits input of actual biometric data. The card bearer must first provide actual biometric data, which are then compared with the stored biometric data. When a match between the two biometrics is determined, the stored data are made available for the data display. Assuming that the biometric data are of a feature that is unique to an individual, this comparison of the actual biometric data provided by the presenting card cardbearer with the stored biometric data are the self-authenticating feature of the self-authenticating data card system that makes the ID card virtually tamper-proof. The biometric data may include data for any number of biometric characteristics, such as a fingerprint, a thumbprint, a voice print, a retinal scan, a facial scan, a digital code of a DNA sequence, etc. Furthermore, data for more than one biometric feature may be included on one self-authenticating data card.

A commonly known and used biometric is that of the fingerprint and, for purposes of illustration only, the fingerprint will be used hereinafter to describe the basic functional features of the self-authenticating data card system. The biometrics sensor, in this case, a fingerprint sensor, is provided directly on the self-authenticating data card and the card bearer is required to provide the actual biometric data, that is, to apply the appropriate fingertip to the sensor. The programmed chip on the self-authenticating data card then compares the sensed fingerprint with the fingerprint stored on the self-authenticating data card and indicates a match or a mismatch. Verification of a match between actual and stored biometric data confirms that the presenting card bearer is the legitimate card bearer. Once a match has been determined, the lock on the data is released and the data are transmitted via the card reader to the data processing unit.

Depending on the type of security for which the self-authenticating data card system is being used, the card bearer now has access to the facilities, services, etc. for which the identification was required. So, for example, if the self-authenticating data card system is used to secure access to a facility or a service, verification of the identity of the card bearer may release a physical barrier or lift a processing block and allow access to the facility or service, respectively. The self-authenticating data card may serve as a general identification card, an employee ID card, a credit/debit or ATM card, an access card for preventing unauthorized access to a computer, a special-event ID card, or any combination thereof.

In some cases, it may be desirable to have security personnel personally verify that the presenting card bearer is indeed the legitimate card bearer. The identity-verification apparatus then includes a display panel. An optional feature of the self-authenticating data card according to the invention is an image of the legitimate card bearer that is veiled, i.e., unreadable without the necessary software and/or apparatus to read it. Upon determining a match between the actual and the stored biometric data, the data lock releases the data, and the image and other pertinent data are unveiled and shown on the display, allowing the security personnel to review the data on the display. Depending on the particular configuration of the identity-verification apparatus, the unveiled image of the card bearer may be magnified to provide better ability to scrutinize the image and compare it with the appearance of the presenting card bearer. The stored image of the card bearer may also be a three-dimensional image, allowing the security person who is also verifying the identity to rotate the image to obtain a view that corresponds with the view presented by the presenting card bearer.

According to the invention, biometric data are encoded and incorporated in the self-authenticating data card such that the data are machine-readable. If the biometric data are to include a fingerprint, the fingerprint is taken from the intended card bearer and converted to electronic form. When the self-authenticating data card is being created, the fingerprint data are downloaded onto a microchip that is incorporated into the self-authenticating data card. As mentioned above, the card is also equipped with a fingerprint sensor. Since the card bearer carries his fingerprint data with him at all times, it is logistically a simple matter to require the presenting card bearer to apply the appropriate fingertip to the fingerprint sensor for purposes of authentication.

It is understood that the identity authentication process just described applies equally well when used with other biometric features and the biometric sensor senses a facial scan, a retinal scan, a voice scan, etc. It is also possible to use a DNA sequence as the stored biometric data. As described above, a DNA sample is taken from the legitimate card bearer, a particular DNA sequence selected and analyzed, and the results stored in digital form and, eventually, downloaded onto the programmed chip in the card. Since the card bearer carries his or her genetic information at all times, it is a relatively simple matter to obtain a sample of DNA from the presenting card bearer at any time and location. For example, a scrape of the inner cheek of the card bearer with a swab provides sufficient tissue to obtain a sample of DNA for analysis. An on-site DNA analyzer, including DNA biometrics sensor, for analyzing the actual DNA sample of the presenting card bearer may be incorporated into the card reader, provided as separate DNA test unit, or provided on a chip that is incorporated onto the self-authenticating data card. The presenting card bearer applies a sample of saliva to the DNA biometrics sensor, which then analyzes the DNA for a particular sequence and transmits the results in digital form to the data lock gate on the self-authenticating data card. If a match is determined, the data lock is released and the stored data made available for processing and/or display.

The particular method of analyzing the DNA sample suitable for use with the self-authenticating data card system is a method based on a hybridization of DNA molecules, as disclosed in U.S. Pat. No. 6,376,177 B1 (Vladimir Poponin; 2002), the complete disclosure of which is incorporated herein by reference. The method and apparatus disclosed therein enable analysis of DNA molecules, using near field surface enhanced Raman scattering for direct spectroscope detection of hybridized DNA molecules and enables analysis of DNA molecules, without the use of radioisotope labels, within a short period of time (minutes).

Another method suitable for use with the self-authenticating data card is a DNA sensor on a chip recently developed by Purdue University. The DNA sensor combines a pulsing laser emitter, a blue light filter, and a photo-detector on a single chip. DNA molecules are tagged with a certain dye. When the molecules are passed under a powerful laser light, the light energy excites the molecules to emit a green light that is transmitted onto a photo-detector. A powerful laser, using “laser liftoff” technology, transfers an LED film from one layer on the chip to a filtering layer, which screens out blue light and allows the photo-detectot to detect only the green light emitted by the DNA molecules.

Once the identity of the presenting card bearer has been authenticated, the card reader transmits the stored data to the data processing unit, which contains proprietary software for processing the stored data. Depending on the particular application of the self-authenticating data card system, the identity-verification apparatus also includes a display panel and data input means. The identity-verification apparatus may be provided as a stationary verification unit. One example of such a stationary unit is that of a card-reader that is mounted on a wall or door and is coupled to a physical barrier, such as a door lock, for example, so that, upon verification, the physical barrier is removed or lifted to allow passage of the card bearer. Another example is that of a unit that is set up at a workstation or checkpoint, such as at an airline ticket gate, or within an automated banking machine system.

The identity-verification apparatus may also be provided as a mobile verification unit. The mobile unit comprises an integrated card-reader/data-processing unit for receiving, reading, and processing the actual biometric data and the stored data, or two separate devices that are in communication with each other: a card reader for reading the card, and a data-processing unit that is preferably a small electronic computing device. The data-processing unit contains software for processing the actual biometric data and the stored data and, if included in the particular configuration of the identity-verification apparatus, a display for revealing the pertinent identity data to the person having control over the identity-verification apparatus. For purposes of illustration only, when discussing the mobile unit, the small electronic computing device will be referred to hereinafter as a personal data assistant (PDA). It should be understood, however, that there are many portable electronic devices that have the capability of storing software and processing data, including cellular telephones. Such devices may or may not be equipped with GPS receiver and transmission capability. In a mobile unit, the card-reader is preferably a sled that is configured to receive and establish an electronic connection with the PDA and the self-authenticating data card, so as to communicate data from the card to the PDA. The sled has circuitry for reading the data on the self-authenticating data card and sending the data through the electronic connection to the PDA that is inserted into the sled. The PDA processes the data received from the self-authenticating data card and provides some indication that a match has or has not been made between the actual biometric data and the stored biometric data.

A key security feature of the self-authenticating data card system according to the invention is that it may be operated as a mobile unit that requires no continuous and/or hard-wired link to a central computer network. The mobile unit offers the advantages of enabling security personnel to verify the identity of persons at virtually any location and of not requiring that floor space be dedicated to an identity-verification workstation. It also allows quick and easy implementation of a temporary verification system, for example, for a special event, or for access to a temporary facility, such as a field hospital in a disaster area.

An example of the use of the identity card system, as a mobile unit, is within the secured area of an airline gate at an airport, in which the group of persons being screened is limited to a specific group and the security demands are high. The individuals in this area have gone through an initial screening when checking in and the airline has processed the information and updated its manifest for the particular flight. Security personnel download the updated manifest onto their identity-verification apparatus and are then able to quickly and easily verify the identity and confirm the presence of each person waiting in the restricted area or passing through the gate to the airplane. This is quickly and easily done by having each person insert his or her self-authenticating data card into the reader and, assuming the biometric data are a fingerprint, pressing the appropriate finger on the card.

Another example of the use of the self-authenticating data card system is within a medical facility. Use of the identity card system in such an application may require that a database of authorized employee numbers or security codes, or some other identifying code, be downloaded onto the identity-verification apparatus as needed, for example, at the beginning of a workshift. The self-authenticating data card for such an application includes the employee number or security code, etc. The data lock authenticates the identity of the presenting card bearer and the data processing unit determines that the stored data includes a code that authorizes the card bearer to gain access to certain services and/or facilities. As mentioned earlier, when the self-authenticating data card is removed from the identity-verification apparatus, the personal data of the card bearer is also removed. It may be desirable to store the access dates and times of the card bearer. In this case, the security code is recorded, along with a time/date stamp, in the data processing unit for uploading to another computer database at another time. This reduces the amount of personal information that is stored in the data processing unit to a minimum, yet provides the desired security and record-keeping.

The self-authenticating data card system according to the invention is particularly well-suited for many applications within a facility in which access to certain locations or services is restricted to certain authorized personnel, and in which it is particularly important to provide certain information about a person, yet prevent that information from being disseminated to unauthorized persons. One such application is in the area of patient care. Medical personnel may have need of information pertaining to a particular patient. In such applications, a personal self-authenticating data card is issued to the patient upon entry into the medical facility or into the medical system. The card contains all relevant medical information about the patient and is readable in the appropriate identity-verification apparatus. Ideally, the biometric feature that is selected as the authentication feature is one that is readable whether or not the patient is conscious. Thus, it may be more desirable to use a facial scan than a voice print, a retinal scan, or even a fingerprint, as the biometric feature that releases the data lock on the card.

In yet another application that is particularly useful for medical personnel, the self-authenticating data card is equipped with a radio frequency (RF) transmitter. At the beginning of the work shift, the card bearer authenticates the card, which then activates the RF transmitter. When the card bearer approaches a locked door, for example, the card broadcasts the authorization code to release the door lock. This is particularly advantageous for medical personnel who scrub their hands and then move from a prep room to an operating room, for example, without touching anything.

The self-authenticating data card system may be tailored for a particular application and may include special card and identity-verification apparatus that contain any number of additional features that are not typically included in a self-authenticating data card system for conventional personal identification. Such additional features may include storing the data for multiple biometeric features on the self-authenticating data card and equipping the identity-verification apparatus with a GPS Rcvr/Xmtr, a wireless transmitter for communicating with a central registry, for example, for sending contemporaneously obtained biometric information and for receiving authorization or verification from a remote site. The wireless transmitter may be designed to connect with a local receiver hub, mobile telecommunications towers, or with the Global Positioning System (GPS) satellite system. As an additional security feature, data destroy instructions may be programmed onto the programmable microchip, so that, when unauthorized use of the self-authenticating data card is detected, an instruction may be sent to the card to erase or render illegible the stored data, making the card useless.

As mentioned earlier, it is possible to force a card bearer to disclose his or her PIN. It is just as possible to force a card bearer to provide the required actual biometric data to gain access to a facility or service. An optional security feature of the self-authenticating data card system according to the invention is the alarm feature, also referred to hereinafter as the 911 code. For illustration purposes, the use of the fingerprint as the biometric data are used, although it is again understood that any biometric feature may be used. It is also understood that the optional security feature requires that the identity-verification apparatus include a GPS Rcvr/Xmtr. At the time the self-authenticating data card is issued, the biometric feature that is used to open the data lock is selected and the data downloaded to the programmable microchip on the card. For the sake of illustration, the selected biometric feature shall be the fingerprint of the ring finger of the right hand. Additional fingerprints may also be recorded and included on the card according to the invention and for the purpose of triggering the 911 code. Use of one of these additional fingerprints causes the data lock to open, thereby allowing the card bearer to gain access to a restricted facility or service, but, at the same time, triggers a call to 911. The GPS Rcvr/Xmtr allows law-enforcement entities to determine the location of the identity-verification apparatus where the unauthorized use of the card occurred.

The identity-verification apparatus may include a data input/output port for exchange of locally stored memory with other computing devices and systems. The identity-verification apparatus may be battery-operated, have a portable external power supply linked to the apparatus, or be solar-powered. Further optional features may enable the card bearer or security personnel to communicate with the identity-verification apparatus via a keypad for entering inputs and setting parameters, accuracy level, etc. A camera may be provided on the identity-verification apparatus for contemporaneously taking a picture of the card bearer.

The self-authenticating data card system described above includes a self-authenticating data card that has a biometric sensor for sensing a biometric feature, such as a fingerprint, and a card reader that reads the data from the card and transmits it to an electronic computing device. The identity-verification apparatus according to the invention may, however, include a separate scanner for recording the actual biometric data. For example, a biometric identifier that may be stored on the self-authenticating data card is a retinal scan or a facial scan. Thus, one embodiment of the card reader may include a separate scanner for scanning the retina or facial structure of the card bearer and comparing it with the stored data on the self-authenticating data card. When used within a medical facility, it is particularly useful if the scanner is on an extension cord and can be maneuvered into a position to read the biometric feature of a patient in a wheelchair on lying on a hospital bed. Other embodiments include a vocal print scanner.

The mobile identity-verification apparatus described above is optionally equipped with GPS receiver-transmitter capability that allows the unit to be tracked in case it should be stolen or misappropriated. The mobile unit may also include a GPS Rcvr/Xmtr attached to a separate internal battery. In case of theft or misappropriation of the mobile unit, a command may be sent to erase the memory of the stolen unit, to prevent disclosure of the software and data contained in it.

The methods of use of the apparatus according to the invention may accommodate a range of security levels. For example, a low security verification procedure may only require a photo ID. The self-authenticating data card may contain a digitally stored, high resolution image of the card bearer that is visually recognizable only when the card is inserted into the identity-verification apparatus. Security personnel are equipped with the identity-verification apparatus according to the invention. The card bearer inserts the self-authenticating data card into the identity-verification apparatus, at which time the image of the card bearer appears as a visually recognizable image on the display of the identity-verification apparatus. The device display may display the image at several times the magnification of the image stored on the card to facilitate a comparison with the appearance of the card bearer. The image may even be a rotatable three-dimensional image, in which case, the person verifying identification of the card bearer may rotate the image shown on the display to obtain a different view for a complete comparision, yielding greater accuracy and reliability of the verification. The self-authenticating data card may include other physical attributes of the legitimate card bearer, such as height, weight, eye color, etc., which are then also displayed on the identity-verification apparatus, to enable a more complete visual comparison between the presenting card bearer and the image of the legitimate card bearer.

Several advantages result from the use of the mobile unit of the identity-verification apparatus. One of these advantages is the reduced floor space needed to establish security checkpoints. In high traffic times, such as during the morning rush-hour in an airport, the line of individuals whose identity must be verified may be quite long. Airports may not want to sacrifice lucrative shopping space for extra checkpoints for rapid processing of such an inflow of individuals, or there may simply be a lack of floor space to install extra security checkpoints. With a portable device for reading a self-authenticating data card, security personnel may process, i.e., verify, the identity of, individuals standing in line and perhaps transmit the verification to the check-in station.

Other advantages of the self-authenticating data card system according to the invention include the quick set-up time and the ability to use the identity-verification apparatus on relatively short notice at remote locations. For example, a temporary medical center is set up at a site of medical emergency, or in a location where terrorist attacks are frequent. With use of the self-authenticating data card system, medical personnel may be provided with identity-verification apparatus that will read and verify the identity of medical personnel and others having authorized access to the site. For such an application, it is particularly advantageous to have identity-verification apparatus that will enable efficient and accurate identity verification without having to invest the time and expense of installing stationary checkpoints. The mobile identity-verification apparatus according to the invention enables the self-authenticating data card system to be used effectively in most locations around the world. This allows the identity-verification apparatus to be used with much reduced or no reliance on land-based telecommunications services, which can be non-existent or unreliable in areas hit by disaster or political strife.

### DESCRIPTION OF THE DRAWINGS

The invention will be described by way of non-limiting example, with reference to the accompanying drawings. In the drawings, like reference numbers indicate identical or functionally similar elements. Additionally, the left-most digit(s) of a reference number identifies the drawing in which the reference number first appears.

FIG. 1 is an illustration of the identity-verification apparatus according to the invention, embodied as a mobile unit, showing a computing device mounted in a card reader.

FIG. 2 is an illustration of the self-authenticating data card that, together with the identity-verification apparatus of FIG. 1, comprises the identity-verification apparatus according to the invention.

FIG. 3 shows the separate components of the identity-verification apparatus of FIG. 1.

FIG. 4 is an illustration of the self-authenticating data card system, showing the self-authenticating data card inserted into the identity-verification apparatus.

FIG. 5 shows data being shown on the display of the card reader, after a match has been determined between contemporaneously obtained biometric data and stored biometric data.

FIG. 6 is a block diagram illustraing a self-authenticating data card system comprising the self-authenticating data card of FIG. 2, a modifed identity-verification apparatus, and a DNA test unit with a DNA sensor.

### DETAILED DESCRIPTION OF THE INVENTION

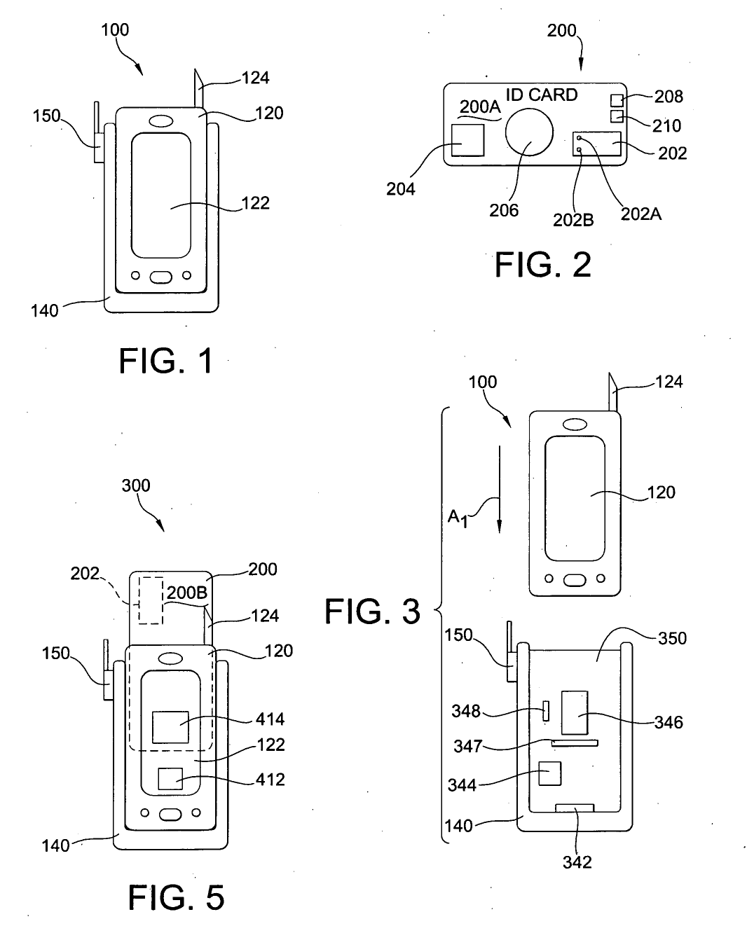

FIG. 1 shows a first embodiment of identity-verification apparatus 100 according to the invention. In the embodiment shown, the identity-verification apparatus 100 is a mobile unit that includes a data-processing unit 120 and a card reader 140. The data-processing unit 120 is a portable, handheld electronic device with a display panel 122, such as a T-MOBILE POCKET PC or an iPaq from COMPAQ. Many different types of PDAs are suitable for use as the data-processing unit 120, as long as the device is able to store and run software for reading and/or processing data coming into it from the card reader 140. The card reader 140 is constructed as a sled for securely holding the data-processing unit 120 and, as an optional feature, is equipped with a GPS receiver-transmitter (GPS Rcvr/Xmtr) capability, as indicated by a GPS antenna 150.

It is understood that it is within the scope of the present invention to provide the identity-verification apparatus 100 as a stationary card-reading unit that is installed in a workstation. In other words, the data-processing unit 120 and the card reader 140 are integrated into a single unit. The stationary card-reading unit is well-known today, as it is typically used to process payments with credit/debit cards, and is, therefore, not separately illustrated.

FIG. 2 shows a self-authenticating data card 200 for use with the identity-verification apparatus 100. The self-authenticating data card contains a programmable microchip 204, a primary biometric sensor 202, and auxiliary biometric sensors 208, 210 that are optional and incorporated in accordance with the particular application of the self-authenticating data card system 100. The programmable microchip 204 contains data in machine-readable form (“stored data”) that identify and/or are pertinent to the legitimate card bearer. Such programmable microchips are well-known for use in a so-called “smart” security card. In the embodiment shown, the programmable microchip 204 used is a microchip from Atmel, with the designation AT 90 SC 6464 C or 3232 C. The stored data include data from at least one biometric feature of the legitimate card bearer, and may also include biographic data, such as name, date of birth, a photographic image, an employee number or social security number, or other data of interest to the organization that issued the self-authenticating data card 200.

The self-authenticating data card 200 has a front face 200A which contains the primary biometric sensor 202 for sensing a biometric feature that corresponds to the at least one biometric feature of the stored data. If the auxiliary biometric sensors 208, 210 are incorporated into the self-authenticating data card 200, they are also provided on the front face 200A. For purposes of illustration, the primary biometric sensor 202 in this particular embodiment is a fingerprint sensor. For example, if fingerprint data are stored on the card as the primary biometric feature, the primary biometric sensor 202 is a fingerprint sensor that scans the print of an actual finger that is applied to the sensor. Fingerprint sensors are well-known and any sensor that is suitable for incorporation onto the self-authenticating data card 200 may be used. In the embodiment shown, the primary biometric sensor 202 is a FIDELICA fingerprint pad, 330 port no. In a preferred embodiment, indicator signals 202A, 202B are provided on the sensor 202. The auxiliary sensors 208, 210 may include a retinal image scanner, a facial image scanner, a voice print scanner, etc. A general information field 206 may be provided on the card if so desired. This field may contain an icon or symbol, for example: a symbol of the U.S. Government if the card is under the control of a governmental agency, or the name or illustration of a hospital or other organization.

FIG. 3 shows the data-processing unit 120 as a separate device from the card reader 140. The two units 120,140 are coupled, as indicated by an arrow A1, to form the identity-verification apparatus 100 according to the invention. Shown in this view is an exposed inner surface 140A of the card reader 140. Mounted on the inner surface 140A is a PDA connector 342, a GPS Rcvr/Xmtr chip 344, a chip-reader circuit 346, a card stop 344, and a power switch 348. The PDA connector 342 is a conventional connector for establishing an electrical connection with the data-processing unit 120 when the data processing unit 120 is inserted into the card reader 140. The chip-reader circuit 346 reads information stored in the programmable microchip 204 on the self-authenticating data card 200. The technology for providing circuitry in devices to read programmable microchips on so-called “smart” cards is widely known and not described with any detail herein. Ideally, the programmable microchip 204 on the self-authenticating data card 200 is a data storage chip with an RF transmitter and the chip-reader circuit 346 is a contactless chip that is capable of receiving the RF transmission from and reading the data stored on the programmable microchip 204. The GPS Rcvr/Xmtr chip 344 is a conventional, commercially available GPS Rcvr/Xmtr chip and, ideally, it also is a contactless chip capable of transmitting/receiving via wireless, i.e., via radio wave transmission. The card reader 140 is so constructed that, when the data-processing unit 120 is inserted into the card reader 140, a card-receiving slot 350 is formed between the inner surface 140A of the card reader 140 and the back of the data-processing unit 120. Inserting the self-authenticating data card 200 far enough into the card-receiving slot 350 until it is arrested by the card stop 347. In this position, the self-authenticating data card 200 activates the power switch 348 to provide the necessary power to the the card reader 140 to transmit data to the data processing unit 120.

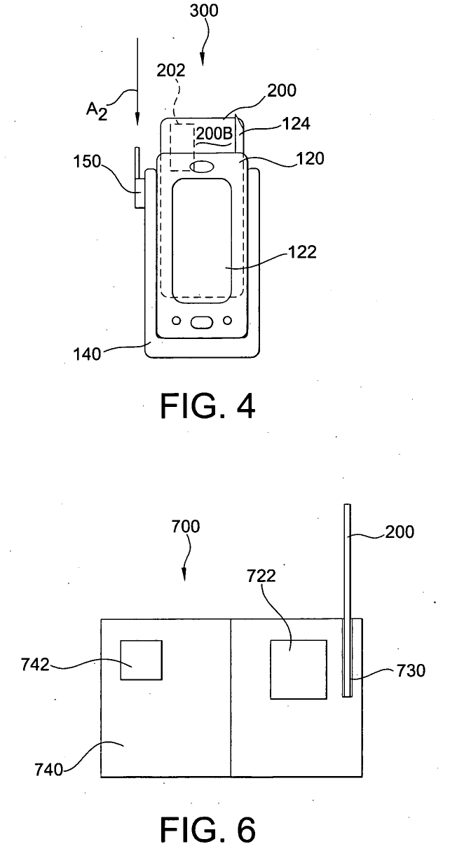

FIG. 4 illustrates the preferred embodiment of an self-authenticating data card system 300 according to the invention, showing the self-authenticating data card 200 being inserted into the card-receiving slot 350 of the identity-verification apparatus 100. The self-authenticating data card 200 is shown being inserted into the identity-verification apparatus 100, with a rear face 200B of the card 200 facing toward the data-processing unit 120 and the front face 200A toward the inner surface 140A of the card reader 140. The card 200 is inserted into the card-receiving slot 350 until it hits the card stop 347 and activates the power switch 348. In this position, the self-authenticating data card 200 is positioned so that the chip-reader 346 is in position to read the stored data on the card. The portion of the self-authenticating data card 200 that is inserted into the identity-verification apparatus 100 is indicated in FIG. 4 with dashed lines. When initially inserted, the display panel 122 of the data-processing unit 120 remains blank, or at least does not display any data from the self-authenticating data card 200, because a data lock programmed on the programmable microchip 204 prevents the stored data from being read until the authorization of the presenting card bearer has been authenticated.

As shown, when properly inserted, the primary biometric sensor 202 is accessible to the presenting card bearer and is ready for sensing data. This is indicated by the NOGO indicator 202B, which, in the embodiment shown is a red LED that, when illuminated, indicates that the sensor is ready for sensing and that no match is being detected. As mentioned earlier, for the sake of illustration the primary biometric sensor 202 is a fingerprint sensor. When the tip of the appropriate finger is applied to the primary biometric sensor 202, the programmable microchip 204 reads the actual biometric data sensed by the primary biometric sensor 202 and compares it with the stored biometric data on the card 200. A match is indicated by the GO indicator 202A, which is a green LED and which, when illuminated, determines that match has been determined. The data lock is then released and the card reader 140 sends the stored data to the data processing unit 120. Depending on the application of the self-authenticating data card system 100, the stored data are displayed on the display panel 122 and/or access to a facility or services is provided. When the self-authenticating data card 200 is removed from the identity-verification apparatus 300, the data that was in the data processing unit 120 for the purpose of displaying the stored data or for releasing access to facilities or services is removed from the data processing unit 120. In other words, the stored data are temporarily held in the data processing unit 120 and erased when the self-authenticating data card 200 is removed from the identity-verification apparatus 300.

In some applications, the self-authenticating data card system 300 according to the invention will be electrically connected to some physical barrier, such as a door lock, and, upon determination of a match between contemporaneously obtained biometric data and stored biometric data, will release the barrier, providing the card bearer access to a secured location. In such applications, it is not necessary that the data-processing unit 120 have a display panel 122. In many other applications, the self-authenticating data card system 300 will be used by security personnel who will personally verify the identity of the card bearer. In such applications, the data-processing unit 120 reveals all or a portion of the stored data on the display panel 122.

FIG. 5 shows the self-authenticating data card system 300 with the self-authenticating data card 200 inserted and after a match has been determined between the contemporaneously obtained biometric data and the stored biometric data. As mentioned above, when a photographic image of the legitimate card bearer is stored on the self-authenticating data card 200, the image is preferably not visible or recognizable to the naked eye on the self-authenticating data card 200. It is either distorted or simply not visible on the card. This is a measure to prevent unauthorized persons who have gained access to the self-authenticating data card 200 and who do not know the legitimate card bearer from imitating the appearance of the legitimate card bearer. Upon determination of a match between the actual biometric data and the stored biometric data, the photographic image is revealed or unveiled on the display panel 122. The self-authenticating data card system 300 shown in FIG. 5 shows a photographic image field 412 and a biographic data field 414. The photographic image 412 is clearly visible and recognizable to the person viewing the display panel 122. Depending on the image software incorporated into the data processing unit 120, the image may be a three-dimension photograph that the person controlling the identity-verification apparatus 100 may rotate in order to obtain an image that enables a more reliable comparison with the image of the individual presenting the self-authenticating data card.

FIG. 6 is an illustration of a self-authenticating data card system 700 that comprises the same self-authenticating data card 200 described above, a modifed identity-verification apparatus 710, and a DNA test unit 740. The stored biometric data includes a machine-readable sequence of DNA. The identity-verification apparatus 710 includes a card insertion slot 730 for receiving the self-authenticating data card 200, a display panel 722 for displaying card bearer information after a match is determined between the stored DNA and contemporaneously provided DNA. The DNA test unit 740 has a sensor 742 for receiving a DNA sample, which is typically a sample of saliva. The DNA test unit 740 is a self-contained unit that incorporates a biosensor that employs near field surface enhanced Raman scattering for direct spectroscopic detection of hybridized DNA molecules. The method of analysis and the apparatus are described in U.S. Pat. No. 6,376,177 B1 and the DNA test unit 740 corresponds to the apparatus disclosed in FIG. 1 of that patent. The DNA test unit 720 transmits the results of the DNA test to the data lock programmed on the programmable chip 204.

1. A self-authenticating security card comprising:
a card substrate;
a programmable microchip embedded in said card substrate;
stored biometric data that is stored on said programmable microchip, said stored biometric data including image data;
a biometric sensor assembled in said card substrate for scanning an applied biometric feature; and
a data lock that compares said applied biometric feature with said stored biometric data in order to determine a match therebetween;
wherein said data lock releases said image data for display only upon determining a match between said applied biometric feature and said stored biometric feature.

2. An identity verification system comprising:
a card substrate;
a programmable microchip embedded in said card substrate;
stored biometric data that is stored on said programmable microchip;
a biometric sensor assembled in said card substrate for scanning an applied biometric feature; and
a data lock that compares said applied biometric feature with said stored biometric data in order to determine a match therebetween; and
a DNA test unit for obtaining and transmitting applied machine-readable DNA information from a DNA sample;
wherein said stored biometric feature includes stored machine-readable DNA information, said applied biometric feature includes said DNA sample and said DNA test unit transmits said applied machine-readable DNA information to said data lock.

3. The identity verification system of claim 2, wherein said DNA test unit transmits via wireless technology said results of said DNA test to said data lock.

4. The identity-verification system of claim 2, wherein said DNA test unit is incorporated on a chip in said card substrate card-reading means that includes a data-processing unit for processing data stored on said security card and a DNA test unit with a DNA sample sensor for on-site DNA analysis; and
wherein, when a DNA sample is applied to said DNA sample sensor, said DNA test unit performs a DNA test and transmits results of said DNA test to said data lock.
